(19) United States
(12) Patent Application Publication
(10) Pub. No.: US 2024/0327957 A1
(43) Pub. Date: Oct. 3, 2024

(54) La-ELEMENT MICRO-ALLOYED AlCrFeNiTi SERIES BULK ALLOY WITH HIGH CORROSION RESISTANCE AND WEAR RESISTANCE, AND PREPARATION METHOD THEREFORE AND APPLICATIONS THEREOF

(71) Applicants: WUHAN UNIVERSITY OF SCIENCE AND TECHNOLOGY, Wuhan (CN); BAND (FOSHAN) METALLIC COMPOSITE MATERIALS CO., LTD., Foshan (CN); SINO-ENERGY HUAYUAN FLOATING WIND INSTITUTE, Qingdao (CN)

(72) Inventor: Kaiming WU, Wuhan (CN)

(73) Assignees: WUHAN UNIVERSITY OF SCIENCE AND TECHNOLOGY, Wuhan (CN); BAND (FOSHAN) METALLIC COMPOSITE MATERIALS CO., LTD., Foshan (CN); SINO-ENERGY HUAYUAN FLOATING WIND INSTITUTE, Qingdao (CN)

(21) Appl. No.: 18/619,231

(22) Filed: Mar. 28, 2024

(30) Foreign Application Priority Data
Mar. 29, 2023 (CN) 2023103245194

(51) Int. Cl. C22C 30/00; B22D 7/06; C22C 1/04

(52) U.S. Cl. CPC C22C 30/00; B22D 7/06; C22C 1/04

(57) ABSTRACT

A La-element micro-alloyed AlCrFeNiTi bulk alloy with high corrosion resistance and wear resistance and a preparation method therefor and applications thereof are provided. The alloy includes the following chemical components in corresponding percentages: 2.05 wt % to 2.15 wt % of Al, 20.50 wt % to 20.65 wt % of Cr, 34.50 wt % to 35.54 wt % of Ni, 18.80 wt % to 19.16 wt % of Ti, 1.05 wt % to 1.15 wt % of La, and the balance of Fe and inevitable impurities, wherein the chemical components need to meet the following three relations at the same time: (1) 18.57≤Fe/La≤22.00; (2) 6.47≤Fe/(La+Al)≤7.45; and (3) 1.05≤Fe/(La+Ti)≤1.16. Compared with AISI 310S stainless steel, the alloy is improved by 280% to 290% in hardness, reduced by 4% to 7% in friction coefficient, and reduced by 17% to 34% in wear amount, increased by 73% to 77% in self-corrosion potential, and decreased by 96% in corrosion current density on average.

### CROSS REFERENCE TO THE RELATED APPLICATIONS

This application is based upon and claims priority to Chinese Patent Application No. 202310324519.4, filed on Mar. 29, 2023, the entire contents of which are incorporated herein by reference.

### TECHNICAL FIELD

The present invention belongs to the technical field of design and preparation of novel alloy materials, and particularly relates to a La-element micro-alloyed AlCrFeNiTi series bulk alloy with high corrosion resistance and wear resistance, and a preparation method therefor and applications thereof.

### BACKGROUND

A multi-principal-element high-entropy alloy material, first proposed by Professor Ye Junwei in 2004, is a novel alloy material with five or more metal elements of equal molar ratios or of approximately equal molar ratios, and it breaks the design concept of traditional alloys taking one element as a principal element, has excellent properties and an unprecedented application prospect, and thus has become a research hotspot in the field of materials in recent years. Under the action of special four effects, a high-entropy alloy has an outstanding academic research value and industrial development potential, and hence provides a new idea for the field of wear-resistant materials.

In the patent technology of “PREPARATION METHOD FOR ALCOCRFENI SERIES DOUBLE-PHASE STRUCTURE HIGH-ENTROPY ALLOY” (CN113025865A), a high-entropy alloy ingot includes the following elements by mass percent: 20.91 wt % to 22.31 wt % of Co. 18.45 wt % to 19.68 wt % of Cr, 19.82 w % to 21.14 wt % of Fe, 26.66 wt % to 31.24 wt % of Ni, and the balance of Al, with the sum of atomic percentages of all the elements being 100%. A high-entropy alloy ingot is prepared by means of vacuum arc smelting and machined into a cast rod. The high-entropy alloy cast rod has the yield strength of 960 MPa, the fracture strength of 1,270 MPa and the ductility of 1.3%. Although this technology obviously improves the strength and the toughness of the high-entropy alloy, its ductility is significantly lower than that of a general high-entropy alloy. Therefore, there is much room for improvement in terms of hardness and wear resistance.

In the patent technology “SUPERHARD WEAR-RESISTANT HIGH-ENTROPY ALLOY AND PREPARATION METHOD THEREFOR” (CN112831710A), a high-entropy alloy ingot includes the following elements by mass percent: basic components of Ta, La, W and Mo, and strengthening components of Fe, Co and Cr, and the basic components are proportioned in conjunction with one or two of the strengthening components at an equal molar ratio. The high-entropy alloy ingot is prepared by means of vacuum are smelting and has the hardness of 1,000 HV to 1,200 HV, and its wear resistance is 4-5 times higher than that of traditional steel. Although this technology obviously improves the hardness and the wear resistance of the high-entropy alloy, the metal elements used are expensive and thus unsuitable for large-scale industrial production.

According to a current study on the wear resistance of an AlCrFeNiTi series high-entropy alloy (Ming-Hao Chuang, Ming-Hung Tsai, Woei-Ren Wang, Su-Jien Lin, Jie-Wei Yeh, Microstructure and wear behavior of AlxCo1.5CrFeNi1.5Tiy high-entropy alloys. Acta Materialia, Volume 59, Issue 16, 2011, Pages 6308-6317, ISSN 1359-6454, https://doi.org/10.1016/j.actamat.2011.06.041.), the wear resistance of the alloy is improved by changing a molar ratio of Al element to Ti element. A four-component high-entropy alloy has the hardness of 450 HV to 720 HV. The wear resistance is 2 to 4 times higher than that of bearing steel and high-speed steel with the same hardness, causing certain limitations to improvement of the hardness and the wear resistance of the high-entropy alloy.

Wear-resistant materials used in corrosive, humid, marine and other ambient conditions require not only wear resistance but also excellent corrosion resistance. The main reason for the corrosion resistance of AISI 310S stainless steel is the addition of a large number of Cr element and Ni element, in which Cr is a main element that determines the corrosion resistance of stainless steel, and an electrode potential of stainless steel is improved in a jumping manner with the increase of Cr element. During a heat treatment process for manufacturing 310S stainless steel, Cr element may be dissolved out of a matrix in the form of a carbide. Although the hardness of a Cr carbide is greater than that of the matrix, and the wear resistance of stainless steel can be improved during the process of in-service wear, the precipitation of the Cr-containing carbide may lead to Cr-depleted areas in some parts of the matrix, which makes the electrode potential of stainless steel drop and on the contrary accelerates corrosion of the stainless steel. Therefore, it is difficult for the AISI 310S stainless steel to ensure that its mechanical properties and corrosion resistance meet more requirements at the same time, while the high-entropy alloy provided by the present invention has higher hardness and excellent wear resistance and corrosion resistance simultaneously.

### SUMMARY

In order to overcome the shortcomings in the prior art, the present invention provides a La-element micro-alloyed AlCrFeNiTi series bulk alloy with high corrosion resistance and wear resistance, and a preparation method therefor and applications thereof.

The present invention provides the following technical solutions.

A La-element micro-alloyed AlCrFeNiTi bulk alloy with high corrosion resistance and wear resistance includes the following chemical components in corresponding percentages by mass: 2.05 wt % to 2.15 wt % of Al, 20.50 wt % to 20.65 wt % of Cr, 34.50 wt % to 35.54 wt % of Ni, 18.80 wt % to 19.16 wt % of Ti, 1.05 wt % to 1.15 wt % of La, and the balance of Fe and inevitable impurities. The chemical components need to meet the following three relations expressed in percentage by mass at the same time: (1) 18.57≤Fe/La≤22.00; (2) 6.47≤Fe/(La+Al)≤7.45; and (3) 1.05≤Fe/(La+Ti)≤1.16.

The La-element micro-alloyed AlCrFeNiTi bulk alloy with high corrosion resistance and wear resistance, provided by the technical solution described above, has a uniformly distributed structure and high hardness and wear resistance, and compared with a traditional wear-resistant material NM500, its wear resistance is improved by 3 to 4 times under the same hardness.

The present invention further provides a preparation method for a La-element micro-alloyed AlCrFeNiTi bulk alloy with high corrosion resistance and wear resistance. The preparation method includes the following steps: proportioning according to the chemical components and their contents of the La-element micro-alloyed AlCrFeNiTi bulk alloy with high corrosion resistance and wear resistance; smelting with a vacuum arc furnace; casting with a copper mold process to obtain an ingot blank, which is a cast-molded material that can be used directly, i.e., the La-element micro-alloyed AlCrFeNiTi bulk alloy with high corrosion resistance and wear resistance.

Specifically, Al, Cr, Fe, Ni, Ti and La elemental particles with a purity of 99.99% are used as raw materials, surface oxides are removed by sanding the surfaces of the raw materials with sandpaper, the sanded raw materials are ultrasonically cleaned in water and alcohol in sequence, and the cleaned raw materials are dried at 50° C. to 80° C. for 0.5-2 hours for later use.

Specifically, the pre-treated small metal particles are weighed according to the amounts of all the elements for preparing the raw materials. The prepared raw materials are placed and smelted by arranging high-melting-point elements below low-melting-point elements.

Specifically, during the process of metal smelting, smelting parameters are set as below: a vacuum degree is 1.5-2.5×10⁻³ Pa, an inert gas is charged to −0.04 MPa to −0.06 MPa, and a smelting current ranges from 250 A to 700 A during the process of smelting.

Specifically, the process of smelting with the vacuum are furnace and casting with a copper mold is used for repeated smelting for 1 to 3 times.

The present invention further provides an application of a La-element micro-alloyed AlCrFeNiTi bulk alloy with high corrosion resistance and wear resistance, which may be used to replace AISI 310S stainless steel in places demanding much on wear resistance and corrosion resistance, such as a stamping die, a fixture, an auxiliary tool and the like. The bulk alloy is also used for preparing tools or dies with high corrosion resistance and wear resistance.

The present invention further provides another application of a La-element micro-alloyed AlCrFeNiTi series bulk alloy with high corrosion resistance and wear resistance, which is used for preparing materials for re-manufacturing mechanical products.

Compared with the prior art, the present invention adopting the technical solutions described above has the following positive effects.

1) According to the present invention, the prepared La-element micro-alloyed AlCrFeNiTi series bulk alloy with high corrosion resistance and wear resistance has a hardness of 780 HV, which is significantly improved relative to a hardness of 600 HV of an alloy system not added with La element.

2) According to the present invention, the prepared La-element micro-alloyed AlCrFeNiTi bulk alloy with high corrosion resistance and wear resistance has more superior wear resistance, which is improved by 3 to 4 times relative to an alloy system not added with La element.

3) Arc smelting is used in the process of preparing the alloy to prevent volatilization loss, and the components of the prepared alloy are subject to little burning loss and are basically the same as the compounding components.

4) The five elements of Al, Cr, Fe, Ni and Ti have similar atomic radii, and a six-element system formed by adding La element has a higher entropy of mixing, which reduces the Gibbs free energy of the system, promotes the formation of a solid solution phase, inhibits the formation of a compound phase and improves the stability of the alloy.

5) The atomic radius of La atom is 160% of the average atomic radius of other atoms. By adding a trace amount of La element, large lattice distortion may be formed in the alloy without affecting the stability of the alloy, such that dislocation slipping is prevented, the solid solution strengthening effect of the alloy is significantly improved, and the alloy with higher hardness and higher wear resistance can be manufactured.

6) The metal elements used in the present invention belong to low-priced metals, which helps to realize industrial mass production.

7) The characteristics of the elements themselves have positive effects on the improvement of properties of the alloy.

Ti: Titanium is a high-melting-point element located in the intermediate transition region of the Periodic Table of Chemical Elements, and thus can easily form an interstitial solid solution structure with the alloy during its binding to an alloy. Therefore, under the action of solid solution strengthening, the comprehensive mechanical properties of the alloy can be improved to some extent. In addition, Ti plays a role of refining a grain structure of the alloy, and the fine and dense structure formed has positive effects on improving the strength and toughness of the alloy. During the process of wearing, Ti element is easily oxidized to form an oxide film, which plays a role of lubrication protection during the process of friction, thus achieving the effect of reducing a wear rate of the alloy.

Cr: Chromium is a main element resistant to high-temperature oxidation in common alloy systems, and because of its characteristic of a high melting point, it produces Cr₂O₃ or a Cr-containing spinel structure during the process of wearing and heating, and forms a dense and continuous oxide layer, such that further contact between a gas and an alloy matrix is prevented and the high-temperature oxidation resistance of the material is improved. In addition, Cr is a strong carbide-forming element and can form a large number of carbides, e.g., Cr₂₃C₆, to effectively improve the wear resistance of the alloy. A higher content of Cr can enhance the hardenability of the alloy, making the alloy less prone to cracking and long in service life under extreme working conditions, e.g., in a quick cooling and heating environment. However, an excessive content of Cr leads to a higher production cost. Therefore, in the present invention, the content of Cr ranges from 20.50 wt % to 20.65 wt %, which ensures that the prepared alloy has excellent practicability in the working environment of alternate cooling and heating, including excellent high-temperature oxidation resistance and favorable wear resistance.

Ni: Nickel is a hard, ductile and ferromagnetic metal that can be highly polished and is resistant to corrosion. Ni is a siderophile element and is liable to bind to Fe in the alloy system to improve the hardness of the alloy. Ni is insoluble in water. A dense oxide film may be formed on the surface of Ni in humid air at room temperature, which can improve the wear resistance of the surface of the alloy while preventing a base metal from being further oxidized.

Al: Aluminum element itself is of an FCC structure and is also an element that promotes the formation of a BCC phase in the alloy system. By adding an appropriate amount of Al element, the BCC phase structure accounts for more of the alloy system, such that the overall strength, hardness and wear resistance of the alloy are improved. Al element has a significant role in regulating and controlling the properties of a dual-phase alloy, thus promoting the formation, inside the alloy, of a bidirectional structure with better properties than a unidirectional structure. Al is a light metal element with an atomic radius of 0.143 nm. By adding Al, the original lattice structure can be distorted, such that the free energy of the system can be reduced and a solid solution strengthening role can be achieved. At the same time, Al may also form a dense oxide film on the surface of the alloy, which improves the high-temperature oxidation resistance and wear resistance of the alloy.

La: Lanthanum can improve the properties of the alloy from various perspectives: an appropriate amount of La can form a wedge-shaped nail when the alloy is oxidized, playing a role of connection between an oxidation-resistant layer and a matrix, such that the adhesiveness and the thermal stability of the oxidation-resistant layer are enhanced, and the service life is prolonged. However, excessive La may lead to a higher degree of oxidation of heat-resistant steel. On the other hand, in the alloy matrix. La reacts with other elements to generate fine compounds, which are precipitated from crystals or dissolved in crystal lattices so as to improve the strength of steel. In addition, La can play a role of modifying inclusions in steel to effectively reduce the impact of cracks caused by the inclusions, thus improving the strength of heat-resistant steel. Therefore, in the present invention, the preferred content of La ranges from 1.05 wt % to 1.15 wt %, achieving excellent high-temperature oxidation resistance while keeping favorable high-temperature strength. Moreover, due to the large atomic size, La may easily aggravate the lattice distortion effect in the alloy system, prevent dislocation slipping, hence improve the strength and hardness of the alloy to a certain extent, and accordingly improve the wear resistance of the alloy.

In summary, according to the present invention, the alloy ingot with excellent hardness and wear resistance is obtained by reasonably controlling the proportions of various elements and the content of La. According to the present invention, the prepared bulk alloy with high wear resistance, containing a trace amount of La element, is suitable for reciprocating mechanical parts, cutting tools and other occasions. The bulk alloy is of a uniformly distributed structure and has high hardness, high wear resistance and excellent corrosion resistance. Compared with AISI 310S stainless steel with excellent wear resistance and corrosion resistance, the bulk alloy provided by the present invention is improved by 280% to 290% in hardness, reduced by 4% to 7% in friction coefficient, and reduced by 17% to 34% in wear amount, increased by 73% to 77% in self-corrosion potential, and decreased by 96% in corrosion current density on average.

### BRIEF DESCRIPTION OF THE DRAWINGS

FIG. 1 is a 1000-fold SEM diagram of a La-element micro-alloyed AlCrFeNiTi series bulk alloy with high corrosion resistance and wear resistance prepared in Embodiment 1 of the present invention;

FIG. 2 is a 1000-fold SEM diagram of a La-element micro-alloyed AlCrFeNiTi series bulk alloy with high corrosion resistance and wear resistance prepared in Embodiment 2 of the present invention;

FIG. 3 is a 1000-fold SEM diagram of a La-element micro-alloyed AlCrFeNiTi series bulk alloy with high corrosion resistance and wear resistance prepared in Embodiment 3 of the present invention; and

FIG. 4 is a 1000-fold SEM diagram of a La-element micro-alloyed AlCrFeNiTi series bulk alloy with high corrosion resistance and wear resistance prepared in Comparative Example 1 of the present invention.

### DETAILED DESCRIPTION OF THE EMBODIMENTS

The principles and features of the present invention will be described below, and the embodiments listed herein are only intended to explain the present invention, rather than limiting the scope of the present invention.

### Embodiment 1

A preparation method for a La-element micro-alloyed AlCrFeNiTi series bulk alloy with high corrosion resistance and wear resistance

The preparation method in this embodiment is described as below.

Al, Cr, Fe, Ni, Ti and La elementary particles with a purity of 99.99% were used as raw materials, the surfaces of the raw materials were first sanded with sandpaper to remove surface oxides, then the sanded raw materials were ultrasonically cleaned in water and alcohol, and the cleaned raw materials were dried at 80° C. for 2 hours for later use. The following components were proportioned by mass percent: 2.05 wt % of Al, 20.50 wt % of Cr, 34.5 wt % of Ni, 18.80 wt % of Ti, 1.05 wt % of La and 23.1 wt % of Fe, A vacuum arc smelting furnace was used for high-temperature smelting. First, the elementary particles were mixed and put into a water-cooled copper crucible of the are smelting furnace, and the crucible was vacuumized. When the vacuum degree reached 2.0×10⁻³ Pa, an inert gas was charged to −0.05 MPa for alloy smelting, with a striking current of 250 A and a smelting current of 350 A. Upon finishing of the smelting, an ingot was tumbled after rapid water cooling, and a super-hard wear-resistant alloy ingot was obtained after repeated smelting for three times. Upon finishing of the smelting, a cast ingot of the alloy was obtained by cooling in the water-cooled copper crucible.

A microhardness testing experiment was performed on a prepared sample (microhardness testing is made by an HV-1,000 Vickers hardness tester). The hardness of the sample in Embodiment 1 of the present invention may reach 763 HV1.

A sliding friction and wear experiment (Bruker, UMT3, USA wear test prototype) was performed on the prepared sample by selecting stainless steel as a grinding material, with a load being 30 N, a working temperature being room temperature and the wear time being 30 min. The alloy was worn in a rotating or linear reciprocating manner, with a rotational speed of 200 r/min or a reciprocating speed of 0.1 m/s. Wear resistance indexes (wear mass and friction coefficient) of the alloy provided by the present invention were obtained.

An electrochemical local corrosion test was performed on a prepared spare sample, the test sample was placed in a 0.5 wt % NaCl solution for corrosion simulation, and dynamic polarization data (self-corrosion potential and corrosion current density) was measured by a Zahner electrochemical workstation.

According to test results, compared with AIS 310S stainless steel, the alloy prepared in this embodiment was improved by 283% in hardness, reduced by 4.7% in friction coefficient, reduced by 17.1% in wear amount, improved by 75.3% in self-corrosion potential, reduced by 97.2% in corrosion current on average, and reduced by 3.2 times in wear amount compared with the alloy not added with La element.

### Embodiment 2

A preparation method of a La-element micro-alloyed AlCrFeNiTi series bulk alloy with high corrosion resistance and wear resistance

The preparation method in this embodiment is described as below.

Al, Cr, Fe, Ni, Ti and La elementary particles with a purity of 99.99% were used as raw materials, the surfaces of the raw materials were first sanded with sandpaper to remove surface oxides, then the sanded raw materials were ultrasonically cleaned in water and alcohol, and the cleaned raw materials were dried at 80° C. for 2 hours for later use. The following components were proportioned by mass percent: 2.15 wt % of Al, 20.65 wt % of Cr. 35.54 wt % of Ni, 19.16 wt % of Ti, 1.15 wt % of La and 21.35 wt % of Fe, A vacuum are smelting furnace was used for high-temperature smelting. First, the elementary particles were mixed and put into a water-cooled copper crucible of the arc smelting furnace, and the crucible was vacuumized. When the vacuum degree reached 2.0×10⁻³ Pa, an inert gas was charged to −0.05 MPa for alloy smelting, with a striking current of 250 A and a smelting current of 350 A. Upon finishing of the smelting, an ingot was tumbled after rapid water cooling, and a super-hard wear-resistant alloy ingot was obtained after repeated smelting for three times. Upon finishing of the smelting, a cast ingot of the alloy was obtained by cooling in the water-cooled copper crucible.

A microhardness testing experiment was performed on a prepared sample (microhardness testing was made by an HV-1,000 Vickers hardness tester). The hardness of the sample in Embodiment 2 of the present invention may reach 786 HV1.

A sliding friction and wear experiment (Bruker, UMT3, USA wear test prototype) was performed on the prepared sample by selecting stainless steel as a grinding material, with a load being 30 N, a working temperature being room temperature and the wear time being 30 min. The alloy was worn in a rotating or linear reciprocating manner, with a rotational speed of 200 r/min or a reciprocating speed of 0.1 m/s. Wear resistance indexes (wear mass and friction coefficient) of the alloy provided by the present invention were obtained.

An electrochemical local corrosion test was performed on a prepared spare sample, the test sample was placed in a 0.5 wt % NaCl solution for corrosion simulation, and dynamic polarization data (self-corrosion potential and corrosion current density) was measured by a Zahner electrochemical workstation.

According to test results, compared with AIS 310S stainless steel, the alloy prepared in this embodiment was improved by 295% in hardness, reduced by 14.3% in friction coefficient, reduced by 34.1% in wear amount, improved by 77.2% in self-corrosion potential, reduced by 97.4% in corrosion current on average, and reduced by 3.4 times in wear amount compared with the alloy not added with La.

### Embodiment 3

A preparation method of a La-element micro-alloyed AlCrFeNiTi series bulk alloy with high corrosion resistance and wear resistance

The preparation method in this embodiment is described as below.

Al, Cr, Fe, Ni, Ti and La elementary particles with a purity of 99.99% were used as raw materials, the surfaces of the raw materials were first sanded with sandpaper to remove surface oxides, then the sanded raw materials were ultrasonically cleaned in water and alcohol, and the cleaned raw materials were dried at 80° C. for 2 hours for later use. The following components were proportioned by mass percent: 2.10 wt % of Al, 20.57 wt % of Cr, 35.02 wt % of Ni, 18.98 wt % of Ti, 1.10 wt % of La and 22.23 wt % of Fe, A vacuum arc smelting furnace was used for high-temperature smelting. First, the elementary particles were mixed and put into a water-cooled copper crucible of the arc smelting furnace, and the crucible was vacuumized. When the vacuum degree reached 2.0×10⁻³ Pa, an inert gas was charged to −0.05 MPa for alloy smelting, with a striking current of 250 A and a smelting current of 350 A. Upon finishing of the smelting, an ingot was tumbled after rapid water cooling, and a super-hard wear-resistant alloy ingot was obtained after repeated smelting for three times. Upon finishing of the smelting, a cast ingot of the alloy was obtained by cooling in the water-cooled copper crucible.

A microhardness testing experiment was performed on a prepared sample (microhardness testing was made by an HV-1,000 Vickers hardness tester). The hardness of the sample in Embodiment 3 of the present invention may reach 772 HV1.

A sliding friction and wear experiment (Bruker, UMT3, USA wear test prototype) was performed on the prepared sample by selecting stainless steel as a grinding material, with a load being 30 N, a working temperature being room temperature and the wear time being 30 min. The alloy was worn in a rotating or linear reciprocating manner, with a rotational speed of 200 r/min or a reciprocating speed of 0.1 m/s. Wear resistance indexes (wear mass and friction coefficient) of the alloy provided by the present invention were obtained.

An electrochemical local corrosion test was performed on a prepared spare sample, the test sample was placed in a 0.5 wt % NaCl solution for corrosion simulation, and dynamic polarization data (self-corrosion potential and corrosion current density) was measured by a Zahner electrochemical workstation.

According to test results, compared with AIS 310S stainless steel, the alloy prepared in this embodiment was improved by 288% in hardness, reduced by 7.5% in friction coefficient, reduced by 23.2% in wear amount, improved by 75.4% in self-corrosion potential, reduced by 97.2% in corrosion current on average, and reduced by 4 times in wear amount compared with the alloy not added with La.

### COMPARATIVE EXAMPLE

### Preparation of La-Free Alloy

The preparation method and the test method are the same as those in Embodiments 1-3, except the difference only in the percentages by mass of the components: 2.10 wt % of Al, 20.57 wt % of Cr, 35.02 wt % of Ni, 18.98 wt % of Ti, 0 wt % of La and 23.33 wt % of Fe. All properties were tested from the same perspective as the embodiments described above. The hardness of the sample in the Comparative Example may reach 199.22 HV1.

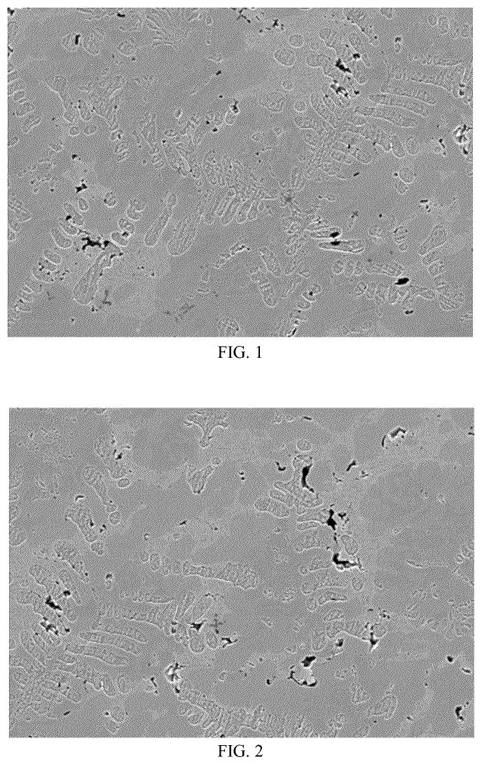

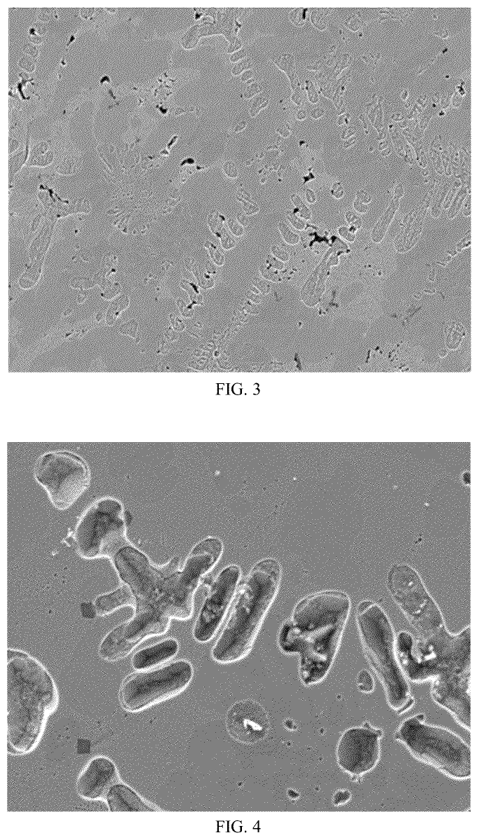

By comparing FIG. 1 to FIG. 4, it can be seen that a dendritic structure of the alloy added with La was obviously refined and dispersed, which reduces the stress concentration of the alloy system, improves the strength and the hardness of the alloy and reduces the wear amount of the alloy. These numerical values were changed more obviously with the increase of La element, which was more beneficial to the wear resistance of the alloy.

It can be seen from the study on Table 2 that compared with AISI 310S stainless steel, the alloy added with La had a higher self-corrosion potential and a lower corrosion current density. These numerical values were changed more obviously with the increase of La element, which was more beneficial to the corrosion resistance of the alloy.

Table 1 shows friction coefficients of the three Embodiments in the present invention and the AISI 310S stainless steel. Compared with the AISI 310S stainless steel with excellent wear resistance and corrosion resistance, Embodiments 1 to 3 achieved lower friction coefficients, which were reduced by 4% to 7%, thereby showing better wear resistance.

TABLE 1

| Sample | Friction coefficient curve |
|---|---|
| AISI 310S stainless steel | 0.4307 |
| Embodiment 1 | 0.4102 |
| Embodiment 2 | 0.3692 |
| Embodiment 3 | 0.3986 |

Table 2 shows fitting results of potentiodynamic polarization of the three Embodiments of the present invention and AISI 310S. Compared with the AISI 310S stainless steel with excellent wear resistance and corrosion resistance, Embodiments 1 to 3 achieved a higher self-corrosion potential and a lower corrosion current density, the self-corrosion potential being increased by 73% to 77% and the corrosion current density being decreased by 96% on average, thereby showing better corrosion resistance.

TABLE 2

| Sample | i(A · cm²) | E (V, vs SCE) |
|---|---|---|
| AISI 310S stainless | 177.0 × 10⁻⁷ | −0.525 |
| steel | | |
| Embodiment 1 | 5.09 × 10⁻⁷ | −0.1421 |
| Embodiment 2 | 4.69 × 10⁻⁷ | −0.1196 |
| Embodiment 3 | 4.98 × 10⁻⁷ | −0.1298 |

The above descriptions are only preferred embodiments of the present invention, and are not intended to limit the present invention. Any modifications, equivalent substitutions, improvements and the like made within the spirit and principles of the present invention should be included within the scope of protection of the present invention.

What is claimed is:

1. A La-element micro-alloyed AlCrFeNiTi bulk alloy with a high corrosion resistance and a wear resistance, comprising chemical components, in weight percentages, of: 2.05 wt % to 2.15 wt % of Al, 20.50 wt % to 20.65 wt % of Cr, 34.50 wt % to 35.54 wt % of Ni, 18.80 wt % to 19.16 wt % of Ti, 1.05 wt % to 1.15 wt % of La, and a balance of Fe and inevitable impurities, wherein the chemical components meet the following three relations expressed in percentage by mass: (1) 18.57≤Fe/La≤22.00; (2) 6.47≤Fe/(La+Al)≤7.45; and (3) 1.05≤Fe/(La+Ti)≤1.16.

2. A preparation method for the La-element micro-alloyed AlCrFeNiTi bulk alloy with the high corrosion resistance and the wear resistance according to claim 1, comprising the following steps: proportioning according to the chemical components and the weight percentages of the La-element micro-alloyed AlCrFeNiTi bulk alloy with the high corrosion resistance and the wear resistance; smelting the chemical components with a vacuum arc furnace to obtain a resulting mixture; casting the resulting mixture with a copper mold process to obtain a cast ingot, wherein the cast ingot is a cast-molded material for a direct use, and the cast ingot is the La-element micro-alloyed AlCrFeNiTi bulk alloy with the high corrosion resistance and the wear resistance.

3. The preparation method for the La-element micro-alloyed AlCrFeNiTi bulk alloy with the high corrosion resistance and the wear resistance according to claim 2, wherein Al, Cr, Fe, Ni, Ti, and La elemental particles with a purity of 99.99% are used as raw materials, surface oxides are removed by sanding surfaces of the raw materials with sandpaper, sanded raw materials are ultrasonically cleaned in water and alcohol in sequence, and cleaned raw materials are dried at 50-80° C. for 0.5-2 hours for a later use.

4. The preparation method for the La-element micro-alloyed AlCrFeNiTi bulk alloy with the high corrosion resistance and the wear resistance according to claim 2, wherein pre-processed metal particles are weighed according to amounts of all elements for proportioning raw materials, and prepared raw materials are placed and smelted by arranging high-melting-point elements below low-melting-point elements.

5. The preparation method for the La-element micro-alloyed AlCrFeNiTi bulk alloy with the high corrosion resistance and the wear resistance according to claim 2, wherein during a process of a metal smelting, smelting parameters are set as below: a vacuum degree is 1.5-2.5×10⁻³ Pa, an inert gas is charged to −0.04 MPa to −0.06 MPa, and a smelting current ranges from 250 A to 700 A.

6. The preparation method for the La-element micro-alloyed AlCrFeNiTi bulk alloy with the high corrosion resistance and the wear resistance according to claim 2, wherein the step of smelting the chemical components with the vacuum arc furnace and the step of casting the resulting mixture with the copper mold process are repeated for 1 to 3 times.

7. A method of an application of the La-element micro-alloyed AlCrFeNiTi bulk alloy with the high corrosion resistance and the wear resistance according to claim 1 in preparing a stamping die, a fixture, or an auxiliary tool.

8. A method of an application of the La-element micro-alloyed AlCrFeNiTi bulk alloy with the high corrosion resistance and the wear resistance according to claim 1 in preparing a tool or a die with the high corrosion resistance and the wear resistance.

9. The preparation method for the La-element micro-alloyed AlCrFeNiTi bulk alloy with the high corrosion resistance and the wear resistance according to claim 3, wherein the step of smelting the chemical components with the vacuum arc furnace and the step of casting the resulting mixture with the copper mold process are repeated for 1 to 3 times.

10. The preparation method for the La-element micro-alloyed AlCrFeNiTi bulk alloy with the high corrosion resistance and the wear resistance according to claim 4, wherein the step of smelting the chemical components with the vacuum arc furnace and the step of casting the resulting mixture with the copper mold process are repeated for 1 to 3 times.

11. The preparation method for the La-element micro-alloyed AlCrFeNiTi bulk alloy with the high corrosion resistance and the wear resistance according to claim 5, wherein the step of smelting the chemical components with the vacuum arc furnace and the step of casting the resulting mixture with the copper mold process are repeated for 1 to 3 times.
